(19) United States
(12) Patent Application Publication
(10) Pub. No.: US 2026/0006307 A1
(43) Pub. Date: Jan. 1, 2026

(54) IMAGE CAPTURING APPARATUS THAT REDUCES VARIATION IN SHOOTING LUMINANCE, LIGHT EMITTING DEVICE, CONTROL METHOD, AND STORAGE MEDIUM

(71) Applicant: CANON KABUSHIKI KAISHA, Tokyo (JP)

(72) Inventor: JUNJI TAKAI, Kanagawa (JP)

(21) Appl. No.: 19/247,252

(22) Filed: Jun. 24, 2025

(30) Foreign Application Priority Data
Jul. 1, 2024 (JP) 2024-106037

(51) Int. Cl. H04N 23/56; H04N 23/60

(52) U.S. Cl. CPC H04N 23/56; H04N 23/60

(57) ABSTRACT

An image capturing apparatus has a light emitting device attached thereto and performs shooting with light emission from the light emitting device. A main light emission amount at a time of image capturing is calculated based on luminance information measured of a photometry area when performing preliminary light emission. Whether to continue image capturing is determined according to a shooting mode. If the main light emission amount is equal to or larger than the light emission amount upper limit value, a difference between the main light emission amount and the light emission amount upper limit value is corrected with an image capturing parameter, and shooting is performed by setting the light emission amount upper limit value as the main light emission amount. If determined to continue image capturing, image capturing corrected with the image capturing parameter is continued.

### BACKGROUND

### Field of the Technology

The present disclosure relates to an image capturing apparatus that reduces variation in shooting luminance, a light emitting device, a control method, and a storage medium.

### Description of the Related Art

As a light emission amount control system used when shooting with light emission is performed, there is generally known a system that performs preliminary light emission before shooting with light emission and then performs the shooting with light emission by calculating a proper light emission amount based on a luminance reflected from an object according to the preliminary light emission. Japanese Patent No. 4547465 discloses a technique in which a light emission amount calculated based on a result of the above-mentioned preliminary light emission and a predetermined light emission amount are compared, and in a case where the light emission amount calculated based on the result of the preliminary light emission is larger than the predetermined light emission amount, shooting is performed with the predetermined light emission amount and a difference of the calculated light emission amount from the predetermined light emission amount is corrected by the image capturing sensitivity. Further, Japanese Laid-Open Patent Publication No. 2020-3567 discloses a technique in which in a case where a continuous shooting priority mode is set, shooting with light emission is performed by making the image capturing sensitivity at the time of shooting higher than when the continuous shooting priority mode is not set.

However, according to the conventional technique disclosed in Japanese Patent No. 4547465, variation in the shooting luminance due to a difference in image capturing sensitivity can occur depending on whether or not the difference in the light emission amount is corrected by the image capturing sensitivity during continuous shooting. Further, in the conventional technique disclosed in Japanese Laid-Open Patent Publication No. 2020-3567, in the case where the continuous shooting priority mode is set, the image capturing sensitivity is increased and noise easily appears in an image.

### SUMMARY

The present disclosure is directed to providing an image capturing apparatus that reduces variation in shooting luminance when strobe shooting is performed, a light emitting device, a control method, and a storage medium.

In a first aspect of the present disclosure, there is provided an image capturing apparatus that has a light emitting device attached thereto, and performs shooting with light emission from the light emitting device, including an image sensor, at least one processor and memory storing instructions that, when executed, configure the at least one processor of the image capturing apparatus to function as: a measurement unit configured to measure a light emission amount of the light emitting device, a setting unit configured to set a light emission amount upper limit value as an upper limit value of the light emission amount, a calculation unit configured to calculate a main light emission amount at a time of image capturing based on luminance information measured by the measurement unit when preliminary light emission is performed, a determination unit configured to determine whether or not to continue image capturing according to a shooting mode, and a control unit that, in a case where the main light emission amount calculated by the calculation unit is equal to or larger than the light emission amount upper limit value set by the setting unit, corrects a difference value between the main light emission amount and the light emission amount upper limit value with an image capturing parameter, and performs image capturing by setting the light emission amount upper limit value as the main light emission amount, and, in a case where the determination unit determines to continue image capturing, continues image capturing corrected with the image capturing parameter.

In a second aspect of the present disclosure, there is provided a method of controlling an image capturing apparatus that has a light emitting device attached thereto, and performs shooting with light emission from the light emitting device, including measuring a light emission amount of the light emitting device, setting a light emission amount upper limit value which is an upper limit value of the light emission amount, calculating a main light emission amount at a time of image capturing based on luminance information measured by the measuring when preliminary light emission is performed, determining whether or not to continue image capturing according to a shooting mode, and correcting, in a case where the main light emission amount calculated by the calculating is equal to or larger than the light emission amount upper limit value set by the setting, a difference value between the main light emission amount and the light emission amount upper limit value with an image capturing parameter, and performing image capturing by setting the light emission amount upper limit value as the main light emission amount, and continuing, in a case where the determining determines to continue image capturing, image capturing corrected with the image capturing parameter.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of a configuration of an image capturing system according to the present disclosure.

FIG. 2 is a flowchart of an image capturing process performed by an image capturing apparatus according to a first embodiment of the present disclosure.

FIG. 3 is a flowchart of an exposure control value correction continuation process performed by the image capturing apparatus.

FIG. 4 is a flowchart of a synchronization speed-setting process performed by the image capturing apparatus according to a second embodiment of the present disclosure.

FIG. 5 is a flowchart of a light emission amount upper limit value-setting process performed by the image capturing apparatus according to the second embodiment of the present disclosure.

FIGS. 6A and 6B are diagrams useful in explaining an example of display of exposure control values of the camera.

FIGS. 7A and 7B are diagrams useful in explaining an example of detection of a main object area in image data.

FIG. 8 is a diagram useful in explaining an example of a relationship between a main emission amount of a strobe device and an exposure value.

FIG. 9 is a diagram useful in explaining a synchronization speed.

FIG. 10 is a diagram useful in explaining a case where an emission amount of the strobe device is limited, and the synchronization speed is reduced.

### DESCRIPTION OF THE EMBODIMENTS

The present disclosure will now be described in detail below with reference to the accompanying drawings showing embodiments thereof.

The embodiments of the present disclosure will be described in detail with reference to the drawings. However, the configurations described in the following embodiments are given only by way of example, and are by no means intended to limit the scope of the present disclosure. A camera body unit 100 described below corresponds to an image capturing apparatus. Further, although described hereinafter, a synchronization speed refers to the highest shutter speed at which a shutter can completely stay open during light emission from a strobe device, and an upper limit of the synchronization speed is normally set to a shutter speed of approximately 1/125 to 1/250 (s). Synchronization speed priority refers to a state in which such a setting of the synchronization speed is automatically and preferentially made by a predetermined operation, and a mode (shooting mode) associated with this is referred to as a synchronization speed priority mode.

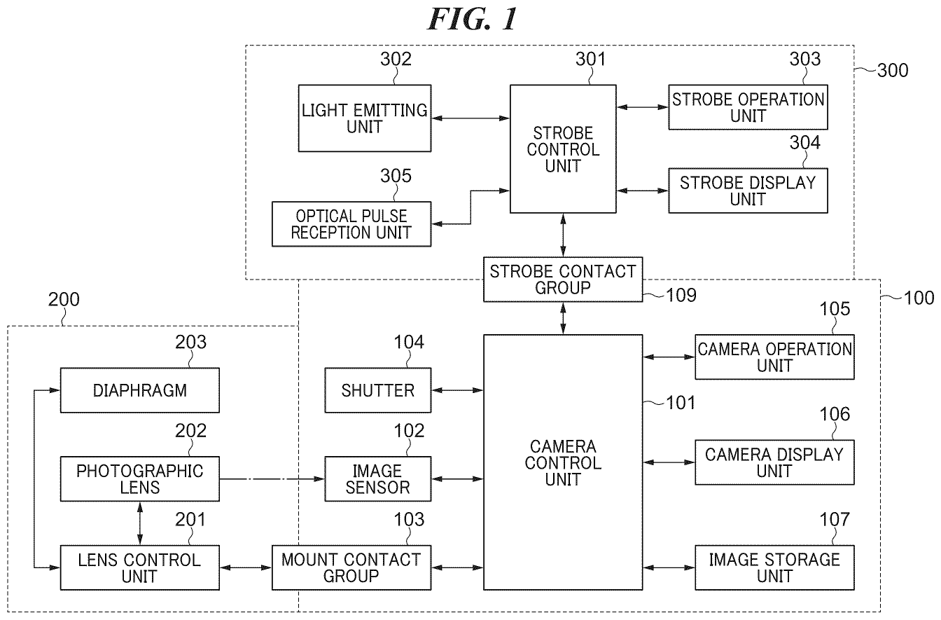

FIG. 1 is a block diagram showing an example of a configuration of an image capturing system. The image capturing system shown in FIG. 1 includes the camera body unit 100, a lens unit 200, and a strobe device 300. The lens unit 200 is attached to the front side of the camera body unit 100. The lens unit 200 is interchangeable, and the camera body unit 100 and the lens unit 200 are electrically connected via a mount contact group 103. On a top surface of the camera body unit 100, the strobe device 300 is mounted. The strobe device 300 is interchangeable, and the camera body unit 100 and the strobe device 300 are electrically connected via a strobe contact group 109.

The camera body unit 100 has a camera control unit 101. To the camera control unit 101, a shutter 104, an image sensor 102, a camera operation unit 105, a camera display unit 106, and an image storage unit 107 are connected. These are connected to the camera control unit 101 in a state enabled to communicate necessary information, and the camera control unit 101 controls these devices connected thereto. For example, the camera control unit 101 is implemented by a microcomputer that controls the operations of the components of the camera body unit 100. More specifically, the camera body unit 100 is comprised of a central processing unit (CPU), a read only memory (ROM), and a random access memory (RAM), and the necessary functions of the present embodiment are realized by the CPU that loads programs stored in the ROM into the RAM and executes the loaded programs.

The image sensor 102 generates image data by converting light from an object, incident through a photographic lens 202, to electrical signals to generate image data, and outputs the generated image data to the camera control unit 101. The shutter 104 is a focal plane shutter and is formed by a front curtain and a rear curtain. More specifically, the front curtain of the shutter 104 travels to open the shutter to thereby start the exposure of the image sensor 102, and the rear curtain of the same travels to close the shutter to thereby terminate the exposure of the image sensor 102. Note that the front curtain and the rear curtain can be configured as a light shielding member for opening and shielding the image sensor 102, or at least one of the front curtain and the rear curtain can be configured as a so-called electronic shutter. That is, reset and read-out of lines of electric charges accumulated in the image sensor 102 in a horizontal direction can be sequentially controlled from an upper end (or lower end) line.

The camera operation unit 105 includes a variety of operation members to be operated by a user. The camera operation unit 105 is comprised of e.g. buttons, switches, a dial, and a connection device, which are provided on the camera body unit 100. The camera operation unit 105 detects an operation instruction provided by a user and sends a signal corresponding to the detected operation instruction to the camera control unit 101. Now, a release button will be described by way of an example of an operation member of the camera operation unit 105. For example, the camera operation unit 105 outputs an instruction signal (hereinafter referred to as the SW1 signal) generated when the user performs an operation of half-pressing the release button and an instruction signal (hereinafter referred to as the SW2 signal) generated when the user performs a fully-pressing operation of deeply pressing the release button, to the camera control unit 101. The camera display unit 106 displays image capturing information, a captured image, and so forth, according to an operation instruction provided by the camera control unit 101. The image storage unit 107 is used to store acquired captured image data, and the camera control unit 101 performs control to write the captured image data into the image storage unit 107.

The camera control unit 101 controls the operations of the camera body unit 100 based on output signals from the camera operation unit 105. In a case where an output signal from the camera operation unit 105 is the SW1 signal, the camera control unit 101 repeats photometry control for driving the image sensor 102 to capture an image and measuring a luminance of an object from the captured image. In addition to this, the camera control unit 101 determines a shutter speed, an aperture value, and an ISO sensitivity, which are to be used at the time of shooting, based on a result of the photometry. Here, the shutter speed, the aperture value, and the ISO sensitivity, which are used at the time of shooting, are collectively referred to as the exposure control values. The camera control unit 101 displays the determined exposure control values on a screen of the camera display unit 106.

In a case where an output signal from the camera operation unit 105 is the SW2 signal, the camera control unit 101 drives a diaphragm 203 in the photographic lens 202, sets the sensitivity (ISO sensitivity) of the image sensor 102, and controls the shutter 104 to irradiate light to the image sensor 102. The camera control unit 101 performs control to display a captured image on the screen of the camera display unit 106 according to image data acquired from the image sensor 102 and write the image data into the image storage unit 107.

Next, the configuration of the lens unit 200 will be described. The lens unit 200 includes a lens control unit 201, the photographic lens 202, and the diaphragm 203. The lens control unit 201 is realized by a microcomputer that controls the operations of the components of the lens unit 200. The photographic lens 202 is comprised of a plurality of lenses for causing an object image to be formed on the image sensor 102. Further, the photographic lens 202 includes therein the diaphragm 203 for adjusting an amount of light and a focus lens (not shown) for adjusting the focus. The lens control unit 201 is controlled via the mount contact group 103 to adjust an amount of light taken into the camera body unit 100 and the focus according to an instruction from the camera control unit 101. The lens control unit 201 is comprised of a CPU, a ROM, and a RAM, and is configured to be capable of adjusting an amount of light taken into the camera body unit 100, the focus, and so forth, by the CPU loading programs stored in the ROM into the RAM and executing the same.

Next, the configuration of the strobe device 300 will be described. The strobe device 300 includes a strobe control unit 301, a light emitting unit 302, a strobe operation unit 303, a strobe display unit 304, an optical pulse reception unit 305, and the strobe contact group 109. The strobe control unit 301 is a microcomputer that controls the operations of the components of the strobe device 300. The strobe control unit 301 is capable of communicating necessary information with the camera control unit 101 via the strobe contact group 109 and performs reception of a light emission control instruction and camera information from the camera body unit 100, transmission of strobe information, and so forth. More specifically, the strobe control unit 301 is comprised of e.g. a CPU, a ROM, and a RAM and performs reception of the light emission control instruction and the camera information from the camera body unit 100, transmission of strobe information, and so forth, by the CPU loading programs stored in the ROM into the RAM and executing the same.

The light emitting unit 302 is realized by a discharge tube, a light emission capacitor, a light emission circuit, a light emission optical system, and so forth, and performs flash light emission. The light emitting unit 302 performs light emission by driving the light emission circuit according to an instruction from the strobe control unit 301 to release the energy charged in the light emission capacitor to the discharge tube to thereby irradiate an object with light via the light emission optical system. The strobe operation unit 303 includes an operation unit operated by a user, detects an operation instruction input by the user via a button, a dial, and so forth, which are disposed on the strobe device 300, and transmits a signal corresponding to the input operation instruction to the strobe control unit 301. The strobe display unit 304 displays a light emission mode or the like according to an instruction from the strobe control unit 301.

The optical pulse reception unit 305 receives an optical pulse emitted from the light emitting unit 302 and reflected from an object and outputs a signal indicative of the received optical pulse to the strobe control unit 301. Further, the light emission amount can be set by the strobe operation unit 303 or be acquired from the camera control unit 101 by communication via the strobe contact group 109. Upon receipt of a control signal from the camera control unit 101 via the strobe contact group 109, the strobe control unit 301 can cause the light emitting unit 302 to emit light with a predetermined light emission amount in synchronism with the image capturing operation of the camera body unit 100. As a result, the camera body unit 100 can measure the amount of light emitted from the strobe device 300.

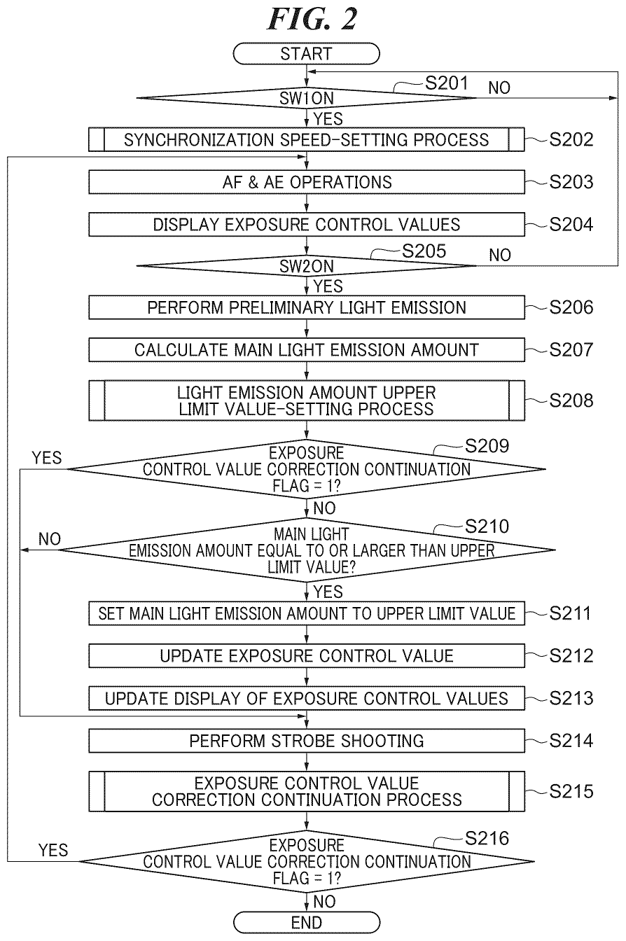

Next, an image capturing process performed by the camera body unit 100 of the present embodiment will be described with reference to FIG. 2. Here, a case is assumed in which shooting is performed in a state in which light emission from the strobe device 300 is set to ON, and an automatic light control mode is selected on the camera body unit 100 as the shooting mode. The automatic light control mode is a mode that realizes image capturing with proper exposure by performing preliminary light emission before image capturing, and calculating a main light emission amount used when shooting is performed based on data of reflected light from an object. The camera body unit 100 can also measure the amount of light emitted from the strobe device 300 in the automatic light control mode.

First, in a step S201, the camera control unit 101 determines whether or not the SW1 signal has been turned on, and if it is determined that the SW1 signal has been turned on (YES in S201), the camera control unit 101 proceeds to a step S202. If it is determined that the SW1 signal has not been turned on (NO in S201), the camera control unit 101 waits in the step S201.

Next, in the step S202, the camera control unit 101 performs a strobe synchronization speed-setting process. In the strobe synchronization speed-setting process in strobe image capturing, when the traveling of the front curtain of the shutter is completed to fully open the screen of the image sensor 102, strobe light emission is permitted. The synchronization speed refers to a shutter speed at which a shutter fully open time period is the shortest when the rear curtain is caused to travel at a timing at which the light emission amount becomes a predetermined amount relative to the value of the maximum light emission amount acquired from the strobe device 300 via the strobe contact group 109.

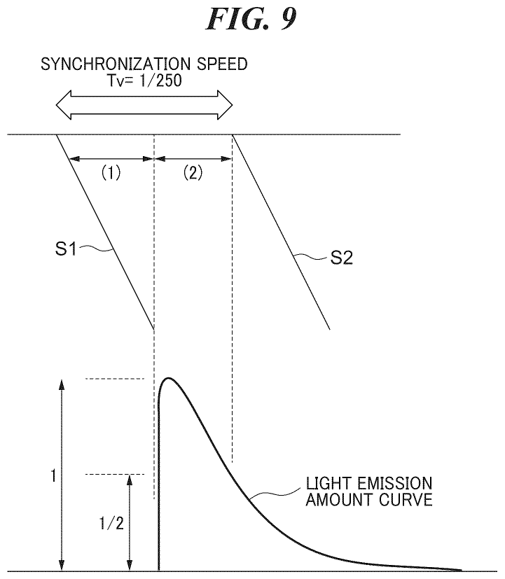

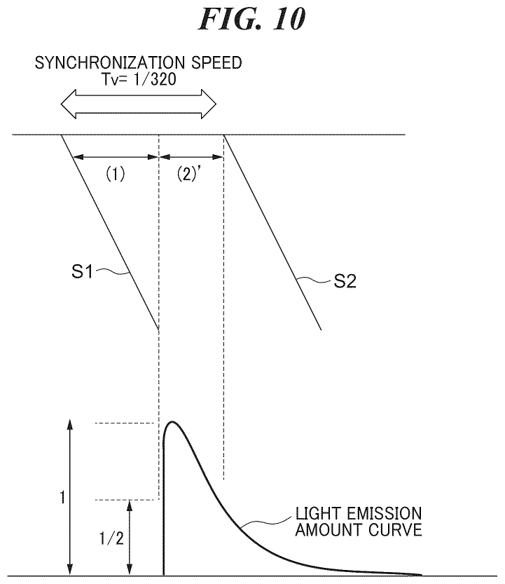

Referring to FIG. 9, S1 indicates traveling of the front curtain of the shutter, and S2 indicates traveling of the rear curtain of the shutter (S1 and S2 in FIG. 10 indicate the same). If the shutter is a mechanical shutter, the image sensor 102 is exposed by traveling of the front curtain of the shutter and is shielded by traveling of the rear curtain of the shutter. If the shutter is an electronic shutter, lines of electric charges accumulated in the image sensor 102 in the horizontal direction are reset according to control of the front curtain of the shutter, and the lines of accumulated electric charges of the image sensor 102 are sequentially read out according to control of the rear curtain.

A time period indicated by (1) in FIG. 9 represents the control of the front curtain of the shutter and is a shutter traveling time. A light emission amount curve in FIG. 9 indicates temporal changes of the light emission amount at the time of strobe emission. The maximum amount of the light emission amount is expressed by 1, and the light emission amount which becomes half of the maximum amount is expressed by ½. The rear curtain starts to travel after the light emission amount is reduced to the light emission amount of ½, and hence (2) in FIG. 9 indicates a fully opening section, and a time period indicated by (1)+(2), i.e. a shutter speed Tv=1/250 (s) becomes the strobe synchronization speed.

Next, in a step S203, the camera control unit 101 executes an autofocus (AF) operation and an auto exposure (AE) operation. That is, in a state in which the strobe device 300 attached to the camera body unit 100 has not emitted light yet, the exposure control values including the shutter speed, the aperture value, and the ISO sensitivity are determined. The upper limit of the shutter speed is set to the synchronization speed (Tv=1/250) set in the step S202. In the present embodiment, it is assumed that the shutter speed (Tv=1/250), the aperture value (F5.6), and the ISO sensitivity (ISO100) are determined as the exposure control values. Next, in a step S204, the camera control unit 101 displays the exposure control values determined in the step S203 on the camera display unit 106.

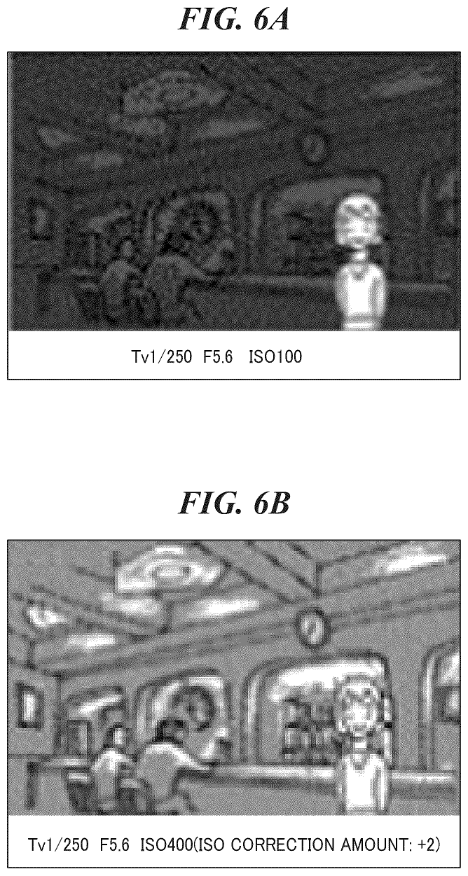

FIG. 6A is a diagram useful in explaining an example of the display of the exposure control values in the present embodiment, i.e. the shutter speed (Tv=1/250), the aperture value (F5.6), and the ISO sensitivity (ISO100). Next, in a step S205, if it is determined that the SW2 signal has been turned on (YES in S205), the camera control unit 101 proceeds to a step S206. If the SW2 signal has not been turned on (NO in S205), the camera control unit 101 waits in the step S201.

Next, in the step S206, the camera control unit 101 acquires luminance information of external light immediately before preliminary light emission from the image sensor 102, calculates luminance values in a plurality of divided photometry areas, and performs preliminary light emission control of the strobe device 300. Note that the camera control unit 101 can also detect an object as a main object in a case where the luminance information measured at the time of the preliminary light emission is equal to or higher than a predetermined value, and detect an object as a sub object in a case where the luminance information is lower than the predetermined value.

Next, in a step S207, the camera control unit 101 acquires the luminance information at the time of preliminary light emission performed in the step S206 from the image sensor 102 and calculates luminance values in the plurality of divided photometry areas. Then, the camera control unit 101 calculates differences between the luminance values of the external light immediately before preliminary light emission, and the luminance values of each divided photometry area at the time of preliminary light emission, and estimates an area where the main object exists at a distance where the main emission is effective.

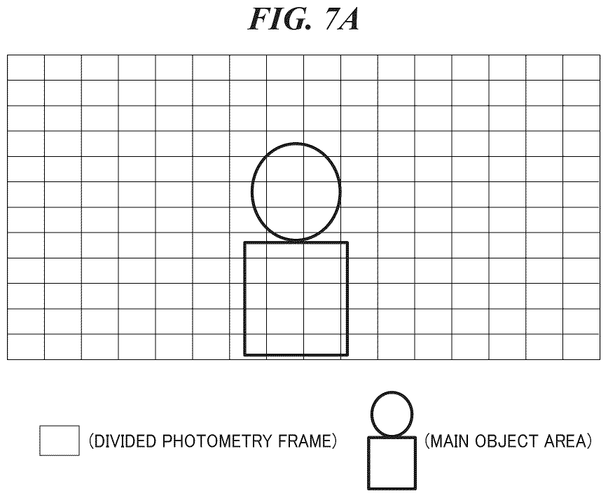

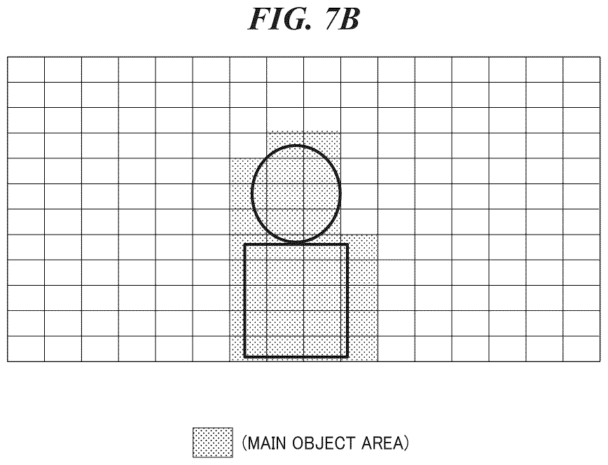

FIGS. 7A and 7B are diagrams showing an example of a main object area and divided photometry frames, which is useful in explaining an example of main object area estimation. In the present embodiment, there is employed a main object area estimation method for estimating, from such an image, that a main object exists at a position where reflected light of preliminary light emission is larger than a predetermined threshold value, in the divided photometry frames. Note that FIGS. 7A and 7B each show an example of the divided photometry frames formed by arranging 12 frames in a vertical direction and 16 frames in a lateral direction.

Here, the sub object (such as a background) area and the main object area can be separated using 0 and 1 therefor, respectively, and the predetermined threshold value can be an absolute value of a luminance level or can be a relative value relative to a luminance level of an area estimated as the background. According to the main object area estimation method described above, in the image data shown in FIG. 7A, gray frames are estimated as the main object area 1 in FIG. 7B. The main light emission amount for the main object area 1 is calculated from a difference between the object luminance of the external light immediately before preliminary light emission and the object luminance at the time of preliminary light emission (the object luminance at the time of preliminary light emission—the object luminance of the external light immediately before preliminary light emission), and a target luminance.

Next, in a step S208, the camera control unit 101 performs a light emission amount upper limit value-setting process, more specifically, acquires the maximum light emission amount from the strobe device 300 via the strobe contact group 109 and sets the acquired maximum light emission amount as the upper limit value of the light emission amount (light emission amount upper limit value). The maximum light emission amount in the present embodiment is assumed to be 1/1 light emission of the full light emission. Next, in a step S209, the camera control unit 101 determines whether or not an exposure control value correction continuation flag is set to 1. If it is determined that the exposure control value correction continuation flag is set to 1 (YES in S209), the camera control unit 101 proceeds to a step S214. On the other hand, if it is determined that the exposure control value correction continuation flag is not set to 1 (NO in S209), the camera control unit 101 proceeds to a step S210. Note that the default value of the exposure control value correction continuation flag is 0.

Next, in the step S210, the camera control unit 101 compares the main light emission amount obtained by calculation of the main light emission amount in the step S207 and the light emission amount upper limit value set in the step S208 to determine whether or not the main light emission amount is equal to or larger than the light emission amount upper limit value (1/1 light emission of full light emission). If the main light emission amount is equal to or larger than the light emission amount upper limit value (1/1 light emission of full light emission) (YES in S210), the camera control unit 101 proceeds to a step S211. On the other hand, if the main light emission amount is smaller than the light emission amount upper limit value (NO in S210), the camera control unit 101 proceeds to the step S214. Next, in the step S211, the camera control unit 101 updates the main light emission amount obtained by calculation of the main light emission amount in the step S207 to the light emission upper limit value (1/1 light emission of full light emission) set in the step S208.

Next, in a step S212, the camera control unit 101 corrects the ISO sensitivity at the time of shooting based on a difference between the main light emission amount calculated in the step S207 and the light emission amount upper limit value set in the step S208, and proceeds to a step S213. Note that correction of the ISO sensitivity is only an example of correcting the difference value of the light emission amount with the exposure control value (image capturing parameter).

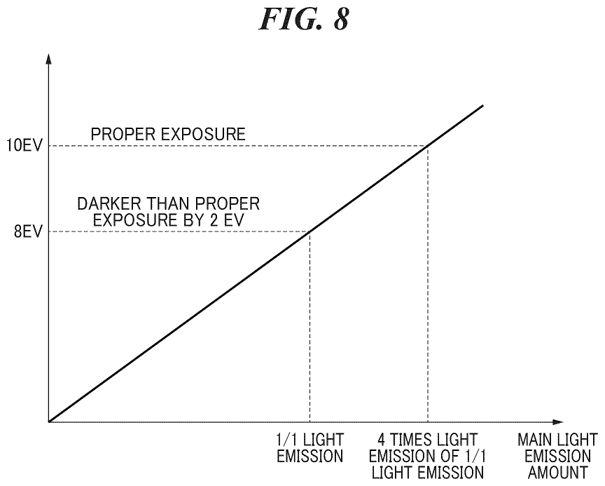

Here, the method of correcting the ISO sensitivity will be specifically described. FIG. 8 is a graph showing a relationship between a strobe main light emission amount and an exposure value, in which a horizontal axis represents the strobe main light emission amount, and a vertical axis represents the exposure value (EV) at the time of the main light emission. In a case where the main light emission amount calculated in the step S207 in FIG. 2 is four times light emission of 1/1 light emission, the exposure value becomes 10 EV, and this indicates that an image of the main object can be captured at proper exposure. On the other hand, with the light emission amount upper limit value set in the step S208, light can be emitted only up to 1/1 light emission as the full light emission, and hence the exposure value can be obtained only up to 8 EV, so that the main object becomes darker by a level corresponding to 2 EV than the proper exposure. That is, the main object becomes darker by 2 EV from the proper exposure. Accordingly, by correcting the ISO sensitivity toward the high sensitivity side by an exposure difference value of 2 EV, it is possible to capture an image of the main object with proper exposure.

Note that in the present embodiment, to perform image capturing with proper exposure, there is employed the method of increasing the strobe light receiving sensitivity by correcting the ISO sensitivity to the high-sensitivity side by a value corresponding to the above-mentioned difference. Besides this, a method of increasing the strobe light receiving amount by correcting the aperture value as an exposure control value to an open side can be employed, or a method of performing both of the ISO sensitivity correction and the aperture value correction can be employed.

Next, in the step S213, the camera control unit 101 displays information that the exposure control value of the ISO sensitivity determined in the step S203 has been updated, on the camera display unit 106. An example of the display in the case where the exposure control value of the ISO sensitivity has been updated will be described with reference to FIG. 6B. In the step S212, since the difference value of 2 EV from the proper exposure is corrected by correcting the ISO sensitivity, to indicate that the ISO sensitivity is increased from ISO 100 determined in the step S203 by 2 EV, ISO correction amount+2 is displayed as illustrated in FIG. 6B.

Next, in the step S214, the camera control unit 101 controls the image sensor 102, the shutter 104, and the lens control unit 201 by using the shutter speed, the lens aperture value, and the ISO sensitivity, which are determined in the step S203, or the ISO sensitivity determined in the step S212. Then, the camera control unit 101 notifies the main light emission amount calculated in the step S207 or S211 to the strobe control unit 301 and executes shooting with light emission by synchronizing the strobe light emission with the exposure timing of the image sensor 102.

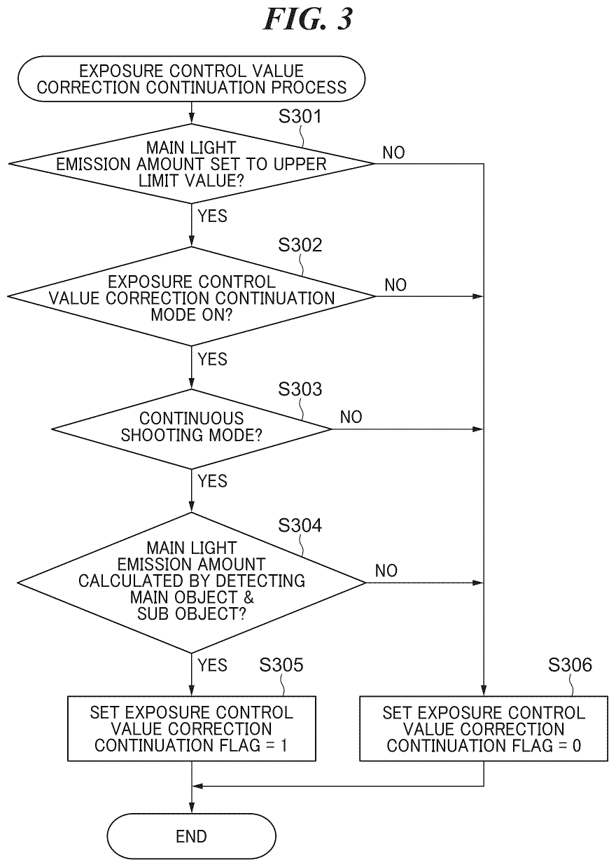

Next, in a step S215, the camera control unit 101 performs an exposure control value correction continuation process. The exposure control value correction continuation process will be described in detail with reference to FIG. 3. First, in a step S301, the camera control unit 101 determines whether or not the main light emission amount calculated in the step S207 has been updated to the light emission amount upper limit value set in the step S208. If it is determined that the main light emission amount has been updated to the light emission amount upper limit value (YES in S301), the camera control unit 101 proceeds to a step S302, whereas if it is determined that the main light emission amount has not been updated to the light emission amount upper limit value (NO in S301), the camera control unit 101 proceeds to a step S306. In the step S306, the camera control unit 101 sets the exposure control value correction continuation flag to 0 to terminate the exposure control value correction, followed by terminating the present process.

Next, in the step S302, the camera control unit 101 determines whether or not the set shooting mode is an exposure control value correction continuation mode (correction continuation mode). The exposure control value correction continuation mode can be set by operating the dial, the switch, and/or the like of the camera operation unit 105, and is a state of continuing correction of the exposure control value. If it is determined that the exposure control value correction continuation mode is ON (YES in S302), the camera control unit 101 proceeds to a step S303, whereas if it is determined that the exposure control value correction continuation mode is not ON (NO in S302), the camera control unit 101 proceeds to the step S306. That is, if the exposure control value correction continuation mode (correction continuation mode) for setting whether or not to continue image capturing corrected with an image capturing parameter is set (is ON), the camera control unit 101 determines to continue image capturing.

Next, in the step S303, the camera control unit 101 determines whether or not the shooting mode is a continuous shooting mode. The continuous shooting mode can be set by operating the dial, the switch, and/or the like, of the camera operation unit 105, and is a state of continuously executing image capturing. If it is determined that the shooting mode is the continuous shooting mode (YES in S303), the camera control unit 101 proceeds to a step S304, whereas if it is determined that the shooting mode is not the continuous shooting mode (NO in S303), the camera control unit 101 proceeds to the step S306. That is, if the continuous shooting mode is set, the camera control unit 101 determines to continue image capturing.

Next, in the step S304, the camera control unit 101 determines whether or not main light emission amount calculation has been performed by detecting a main object area and a sub object area in the main light emission amount calculation in the step S207. As a result of this determination, if the main light emission amount calculation has been performed by detecting a main object area and a sub object area as shown in FIG. 7B (YES in S304), the camera control unit 101 proceeds to a step S305. That is, if the main light emission amount calculation has been performed by the main light emission amount calculation processing in the step S207 by detecting a main object area and a sub object area, the camera control unit 101 determines to continue image capturing. Otherwise (NO in S304), the camera control unit 101 proceeds to the step S306.

Then, in the step S305, the camera control unit 101 sets the exposure control value correction continuation flag to 1 to continue the exposure control value correction, followed by terminating the present process.

Referring again to FIG. 2, in a step S216, the camera control unit 101 determines whether or not to continue exposure control value correction. That is, if it is determined that the exposure control value correction continuation flag, set in the step S215, is 1 (YES in S216), the camera control unit 101 returns the process to the step S203 and continues image capturing. On the other hand, if it is determined that the exposure control value correction continuation flag is 0 (NO in S216), the camera control unit 101 terminates the image capturing process in FIG. 2.

With the above-described control, by increasing the image capturing sensitivity during continuous strobe image capturing and continuously performing image capturing, it is possible to reduce variation in shooting luminance at the time of strobe image capturing. Further, correction of the difference between the calculated main light emission amount and the set light emission amount upper limit value with an image capturing parameter can be executed, for example, as follows: The camera control unit 101 performs one of (1) correction of the image capturing sensitivity to the high-sensitivity side, (2) correction of the lens aperture value in the opening direction, and (3) both of correction of the image capturing sensitivity toward the high-sensitivity side and correction of the lens aperture value in the opening direction.

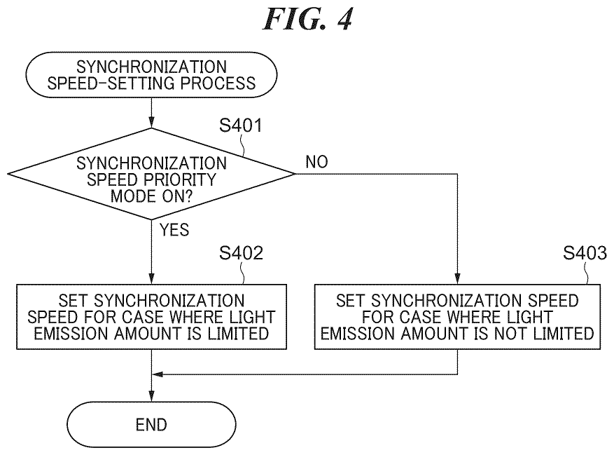

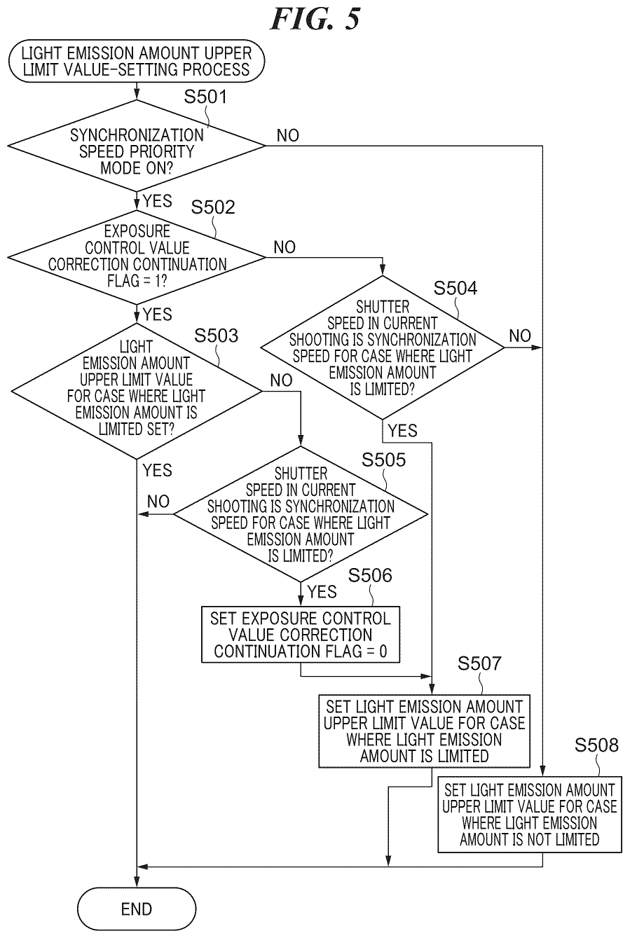

Next, a second embodiment will be described. In the second embodiment, the operation of the image capturing apparatus in a case where the camera body unit 100 further has the synchronization speed priority mode will be described. The image capturing process in the second embodiment is basically the same as the image capturing process in FIG. 2. However, the synchronization speed-setting process in the step S202 and the light emission amount upper limit value-setting process in the step S208 will be described as the processes including the synchronization speed priority mode, with reference to FIGS. 4 and 5.

First, the synchronization speed-setting process will be described with reference to FIG. 4. First, in a step S401, the camera control unit 101 determines whether or not the synchronization speed priority mode is set to ON. The synchronization speed priority mode refers to a mode in which the synchronization speed is made higher than the synchronization speed, described in the first embodiment, with reference to FIG. 9. Specifically, as shown in FIG. 10, the synchronization speed can be realized by limiting the light emission amount (reducing the light emission time) to thereby set a reduced fully opening section (2)′. FIG. 10 shows the synchronization speed Tv=1/320 (s) shorter than that shown in FIG. 9, and, similar to FIG. 9, the time period indicated by (1) represents the control of the front curtain of the shutter and is the traveling time. The maximum value of the light emission amount is set to 1, and traveling of the rear curtain is started after the light amount is reduced to ½ of the maximum value. In FIG. 10, (2)′ indicates the fully opening section.

In the second embodiment, in a case where the synchronization speed priority mode is not set to ON, the synchronization speed is set to Tv=1/250, and the light emission amount upper limit value is set to 1/1 light emission. On the other hand, in a case where the synchronization speed priority mode is set to ON, the synchronization speed is set to Tv=1/320, and the light emission amount upper limit value is set to 1/4 light emission. If it is determined, as a result of the determination on the setting of the synchronization speed priority mode, that the synchronization speed priority mode is set to ON (YES in S401), the camera control unit 101 proceeds to a step S402, whereas if it is determined that the synchronization speed priority mode is not set to ON (NO in S401), the camera control unit 101 proceeds to a step S403.

Next, in the step S402, the camera control unit 101 sets the synchronization speed (Tv=1/320) for the case where the light emission amount is limited and terminates the synchronization speed-setting process. Further, in the step S403, the camera control unit 101 sets the synchronization speed (Tv=1/250) for the case where the light emission amount is not limited and terminates the synchronization speed-setting process. In the next step S203, similar to the first embodiment, the exposure control values are determined, but as for the upper limit value of the shutter speed, if it is determined in the step S401 that the synchronization speed priority mode is set to ON, the shutter speed can be controlled up to (TV=1/320).

Next, the light emission amount upper limit value-setting process according to the second embodiment, which corresponds to the step S208 in FIG. 2, will be described with reference to FIG. 5. First, in a step S501, the camera control unit 101 determines whether or not the synchronization speed priority mode is set to ON. If it is determined that the synchronization speed priority mode is set to ON (YES in S501), the camera control unit 101 proceeds to a step S502, whereas if it is determined that the synchronization speed priority mode is not set to ON (NO in S501), the camera control unit 101 proceeds to a step S508.

Next, in the step S502, the camera control unit 101 determines whether or not the exposure control value correction continuation flag is set to 1. If it is determined that the exposure control value correction continuation flag is set to 1 (YES in S502), the camera control unit 101 proceeds to a step S503, whereas if it is determined that the exposure control value correction continuation flag is not set to 1 (NO in S502), the camera control unit 101 proceeds to a step S504. Note that in the second embodiment, in a case where it is the first image capturing time, or the exposure control value correction is not in a continued state, the light emission amount upper limit value is set in a step S507 or the step S508, described hereinafter.

Next, in the step S503, the camera control unit 101 determines whether or not the light emission amount upper limit value for the case where the light emission amount is limited is set. In the step S503, the exposure control value correction continuation flag is set to 1, and the exposure control value correction is being continued. Therefore, if it is determined that the light emission amount upper limit value for the case where the light emission amount is limited is set (YES in S503), the camera control unit 101 terminates the light emission amount upper limit value-setting process without updating the set light emission amount upper limit value.

On the other hand, if it is determined that the light emission amount upper limit value for the case where the light emission amount is limited is not set (NO in S503), in other words, if it is determined that the light emission amount upper limit value for the case where the light emission amount is not limited is set, the camera control unit 101 executes the following processing: There is a possibility that the setting of the light emission amount upper limit value is to be updated, and hence the camera control unit 101 proceeds to a step S505. Next, in the step S505, the camera control unit 101 determines whether or not the shutter speed in the current shooting operation is the synchronization speed for the case where the light emission amount is limited.

In the step S505, the light emission amount upper limit value for the case where the light emission amount is not limited is set. Therefore, if the shutter speed in the current shooting is not the synchronization speed for the case where the light emission amount is limited (NO in S505), i.e. if the shutter speed in the current shooting is the synchronization speed for the case where the light emission amount is not limited, the camera control unit 101 terminates the light emission amount upper limit value-setting process without updating the light emission amount upper limit value.

On the other hand, if the shutter speed in the current shooting is the synchronization speed for the case where the light emission amount is limited, 1/1 light emission as the light emission amount upper limit value for the case where the light emission amount is not limited is switched to 1/4 light emission as the light emission amount upper limit value for the case where the light emission amount is limited in the step S507. Therefore, if the ISO sensitivity correction amount at the last image capturing time is continuously used, the exposure becomes insufficient by an amount reduced by limiting the main light emission amount from 1/1 to 1/4. Therefore, the camera control unit 101 proceeds to the next step S506 to clear the exposure control value correction continuation flag to 0, and the steps S211 and S212 are executed again.

Next, in the step S504, the camera control unit 101 determines whether or not the shutter speed in the current shooting is the synchronization speed for the case where the light emission amount is limited. If it is determined that the shutter speed in the current shooting is the synchronization speed for the case where the light emission amount is limited (YES in S504), the camera control unit 101 proceeds to the step S507. On the other hand, if it is determined that the shutter speed in the current shooting is not the synchronization speed for the case where the light emission amount is limited (NO in S504), in other words, if it is determined that the shutter speed in the current shooting is the synchronization speed for the case where the light emission amount is not limited, the camera control unit 101 proceeds to the step S508.

Then, in the step S507, the camera control unit 101 sets the light emission amount upper limit value for the case where the light emission amount is limited, followed by terminating the present process. Further, in the step S508, the camera control unit 101 sets the light emission amount upper limit value for the case where the light emission amount is not limited, followed by terminating the present process.

With the above-described control, it is possible to reduce variation in the shooting luminance at the time of strobe image capturing by increasing the image capturing sensitivity during continuous strobe image capturing and continuing image capturing. That is, in a case where the strobe speed is increased through reduction of the shutter fully open time period by limiting the strobe light emission amount (light emission time), the exposure level sometimes becomes lower by approximately 2 steps than proper light control because the shutter fully open time period is reduced by limiting the light emission amount.

At this time, when the shutter speed Tv varies e.g. during continuous shooting, variation in light control is caused in continuously captured images. However, in a case where a result of the light control exceeds the light emission amount limited value (light emission amount upper limit value), the light emission amount is set to the light emission amount limited value, and a difference value between the proper light emission amount and the light emission amount limited value is corrected with the image capturing parameter, whereby shooting is performed by setting the light emission amount upper limit value to the main light emission amount. When correcting the difference value with the image capturing parameter, for example, processing for performing image capturing by adding the above-mentioned difference to the ISO sensitivity is executed.

With these, it is possible to continue the proper light control by correcting the difference between the proper light control amount and the light emission amount limited value with the ISO sensitivity after limiting the light emission amount in strobe continuous shooting, and it is possible to reduce variation in the shooting luminance at the time of strobe image capturing during the continuous strobe image capturing. The present disclosure has been described heretofore based on the embodiments thereof. However, the present disclosure is not limited to these embodiments, but the disclosure includes various modifications and variations within the scope of the gist of the present disclosure. For example, although in the present embodiment, the camera body unit 100 and the strobe device 300 have been described as the separate devices, these can be integrated into one apparatus.

(1) Although the camera control unit 101 acquires luminance information of external light immediately before preliminary light emission from the image sensor 102 and calculates luminance values in the plurality of divided photometry areas in the step S206 as described above, the following process can be executed at this time: The camera control unit 101 can determine that a main object is detected in a case where the luminance information measured at the time of preliminary light emission is not lower than a predetermined value, and a sub object is detected in a case where the luminance information is lower than the predetermined value.

(2) Further, the camera control unit 101 perform shooting at a second shutter speed higher than a first shutter speed, and in a case where next shooting is performed at a shutter speed lower than the second shutter speed, image capturing with a corrected image capturing parameter can be continued. Further, the camera control unit 101 can enable the image capturing process in FIG. 2 when the continuous shooting is set for a drive mode during driving.

According to the present disclosure, it is possible to reduce variation in the shooting luminance at the time of strobe image capturing by increasing the image capturing sensitivity during continuous strobe image capturing and continuing image capturing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-106037 filed Jul. 1, 2024, which is hereby incorporated by reference herein in its entirety.

What is claimed is:

1. An image capturing apparatus that has a light emitting device attached thereto, and performs shooting with light emission from the light emitting device, comprising:
an image sensor;
at least one processor and memory storing instructions that, when executed, configure the at least one processor of the image capturing apparatus to function as:
a measurement unit configured to measure a light emission amount of the light emitting device;
a setting unit configured to set a light emission amount upper limit value as an upper limit value of the light emission amount;
a calculation unit configured to calculate a main light emission amount at a time of image capturing based on luminance information measured by the measurement unit when preliminary light emission is performed;
a determination unit configured to determine whether or not to continue image capturing according to a shooting mode; and
a control unit that, in a case where the main light emission amount calculated by the calculation unit is equal to or larger than the light emission amount upper limit value set by the setting unit, corrects a difference value between the main light emission amount and the light emission amount upper limit value with an image capturing parameter, and performs image capturing by setting the light emission amount upper limit value as the main light emission amount, and, in a case where the determination unit determines to continue image capturing, continues image capturing corrected with the image capturing parameter.

2. The image capturing apparatus according to claim 1, wherein in a case where the shooting mode is set to a continuous shooting mode for capturing a plurality of continuous images, the determination unit determines to continue image capturing.

3. The image capturing apparatus according to claim 1, wherein in a case where the shooting mode is set to a correction continuation mode for continuing image capturing corrected with an image capturing parameter, the determination unit determines to continue image capturing.

4. The image capturing apparatus according to claim 1, wherein in a case where the calculation unit calculates the main light emission amount by detecting a main object and a sub object, the determination unit determines to continue image capturing.

5. The image capturing apparatus according to claim 1, wherein in a case where a synchronization speed priority mode is not set, the setting unit sets a light emission amount upper limit value for a case where the light emission amount of the light emitting device is not limited.

6. The image capturing apparatus according to claim 1, wherein in a case where a synchronization speed priority mode is set and the determination unit determines that image capturing is not to be continued, and at the same time in a case where a shutter speed in the current shooting is a synchronization speed for a case where the light emission amount of the light emitting device is limited, the setting unit sets a light emission amount upper limit value for the case where the light emission amount is limited.

7. The image capturing apparatus according to claim 4, wherein the control unit further detects, in a case where luminance information measured of a photometry area by the measurement unit when preliminary light emission is performed is equal to or higher than a predetermined value, the photometry area as a main object, and detects, in a case where the luminance information is lower than the predetermined value, the photometry area as a sub object.

8. The image capturing apparatus according to claim 1, wherein the control unit further performs image capturing at a second shutter speed higher than a first shutter speed, and continues, in a case where the shutter speed of next image capturing is lower than the second shutter speed, image capturing with the corrected image capturing parameter.

9. The image capturing apparatus according to claim 1, wherein the image capturing parameter is an image capturing sensitivity or a lens aperture value, and
wherein correction of the difference value with an image capturing parameter refers to one of correction of an image capturing sensitivity toward a high-sensitivity side, correction of a lens aperture value in an opening direction, and both of correction of the image capturing sensitivity toward the high-sensitivity side and correction of the lens aperture value in the opening direction.

10. The image capturing apparatus according to claim 1, further comprising a display unit configured to display the difference value.

11. A light emitting device attachable to an image capturing apparatus and configured to emit light for image capturing by the image capturing apparatus, comprising:
a light emitting unit configured to emit light in response to a control signal from the image capturing apparatus;
at least one processor and memory storing instructions that, when executed, configure the at least one processor of the image capturing apparatus to function as:
a reception unit configured to receive, from the image capturing apparatus, a light emission amount upper limit value and a main light emission amount to be used for image capturing;
a comparison unit configured to compare the received light emission amount upper limit value and main light emission amount; and
a control unit configured to, in a case where the main light emission amount is equal to or larger than the light emission amount upper limit value, control the light emitting unit to emit light at the light emission amount upper limit value, and
in a case where the main light emission amount is smaller than the light emission amount upper limit value, control the light emitting unit to emit light at the main light emission amount.

12. A method of controlling an image capturing apparatus that has a light emitting device attached thereto, and performs shooting with light emission from the light emitting device, comprising:
measuring a light emission amount of the light emitting device;
setting a light emission amount upper limit value which is an upper limit value of the light emission amount;
calculating a main light emission amount at a time of image capturing based on luminance information measured by the measuring when preliminary light emission is performed;
determining whether or not to continue image capturing according to a shooting mode; and
correcting, in a case where the main light emission amount calculated by the calculating is equal to or larger than the light emission amount upper limit value set by the setting, a difference value between the main light emission amount and the light emission amount upper limit value with an image capturing parameter, and performing image capturing by setting the light emission amount upper limit value as the main light emission amount, and continuing, in a case where the determining determines to continue image capturing, image capturing corrected with the image capturing parameter.

13. A method of controlling a light emitting device attachable to an image capturing apparatus, comprising:
receiving, from the image capturing apparatus, a light emission amount upper limit value and a main light emission amount to be used for image capturing;
comparing the received main light emission amount and light emission amount upper limit value;
in a case where the main light emission amount is equal to or larger than the light emission amount upper limit value, emitting light at the light emission amount upper limit value; and
in a case where the main light emission amount is smaller than the light emission amount upper limit value, emitting light at the main light emission amount.

14. A non-transitory computer-readable storage medium storing a program for causing a computer to execute a method of controlling an image capturing apparatus that has a light emitting device attached thereto, and performs shooting with light emission from the light emitting device,
wherein the method comprises:
measuring a light emission amount of the light emitting device;
setting a light emission amount upper limit value which is an upper limit value of the light emission amount;
calculating a main light emission amount at a time of image capturing based on luminance information measured by the measuring when preliminary light emission is performed;
determining whether or not to continue image capturing according to a shooting mode; and
correcting, in a case where the main light emission amount calculated by the calculating is equal to or larger than the light emission amount upper limit value set by the setting, a difference value between the main light emission amount and the light emission amount upper limit value with an image capturing parameter, and performing image capturing by setting the light emission amount upper limit value as the main light emission amount, and continuing, in a case where the determining determines to continue image capturing, image capturing corrected with the image capturing parameter.

15. A non-transitory computer-readable storage medium storing a program for causing a computer to execute a method of controlling a light emitting device attachable to an image capturing apparatus,
wherein the method comprises:
receiving, from the image capturing apparatus, a light emission amount upper limit value and a main light emission amount to be used for image capturing;
comparing the received light emission amount upper limit value and main light emission amount;
in a case where the main light emission amount is equal to or larger than the light emission amount upper limit value, emitting light at the light emission amount upper limit value; and
in a case where the main light emission amount is smaller than the light emission amount upper limit value, emitting light at the main light emission amount.
